(19) United States
(12) Patent Application Publication
(10) Pub. No.: US 2002/0194489 A1
(43) Pub. Date: Dec. 19, 2002

(54) System and method of virus containment in computer networks

(76) Inventors: Gal Almogy, Stanford, CA (US); Avner Halperin, Tel-Aviv (IL)

Correspondence Address: DANIEL J SWIRSKY, PO BOX 2345, BEIT SHEMESH, 99544, IL

(21) Appl. No.: 09/993,591

(22) Filed: Nov. 27, 2001

Related U.S. Application Data
(60) Provisional application No. 60/298,390, filed on Jun. 18, 2001.

(51) Int. Cl. G06F 11/30

(52) U.S. Cl. 713/200

(57) ABSTRACT

A computer virus detection and containment system is provided including at least one computer configured with at least one decoy address, and a server operative to identify activity occurring at the computer, the activity involving the decoy address.

### CROSS-REFERENCE TO RELATED APPLICATIONS

This application claims the benefit of U.S. Provisional Patent Application Ser. No. 60/298,390, filed Jun. 18, 2001, and entitled “System and Method of Antivirus Protection in Computer Networks,” incorporated herein by reference in its entirety.

### FIELD OF THE INVENTION

The present invention relates to computer and computer network security in general, and more particularly to detection and prevention of malicious computer programs.

### BACKGROUND OF THE INVENTION

A “computer virus” is a computer program that is designed to infiltrate computer files and other sensitive areas on a computer, often with the purpose of compromising the computer's security, such as by erasing or damaging data that is stored on the computer or by obtaining and forwarding sensitive information without the computer user's permission, or with the purpose of spreading to as many computers as possible. In most cases, viruses are spread when computer users send infected files to other computer users via electronic mail (e-mail), via data storage media such as a diskette or a compact disc, or by copying infected files from one computer to another via a computer network.

Some viruses are capable of spreading from computer to computer with little or no intervention on the part of the computer user. These viruses are designed to copy themselves from one computer to another over a network, such as via e-mail messages. A virus that spreads via email messages will typically access an e-mail program's address book or sent/received mail folders and automatically send itself to one or more of these addresses. Alternatively, the virus may attach itself to otherwise innocuous e-mail messages that are sent by a computer user to unsuspecting recipients. Other viruses appear on web pages and are spread by being downloaded into a user's computer automatically when the infected web page is viewed.

The standard approach to protecting against computer viruses is to detect their presence on a computer or network using a virus scanner. However, while virus scanners can effectively detect known computer viruses, they generally cannot reliably detect unknown computer viruses. This is because most virus scanners operate by searching a computer for tell-tale byte sequences known as “signatures” that exist in known viruses. Thus, by definition, new viruses whose byte sequences are not yet known to virus scanners cannot be detected in this manner.

Another approach involves using antivirus software that employs heuristic techniques to identify typical virus behavior by characterizing legitimate software behavior and then identifying any deviation from such behavior. Unfortunately, computer user behavior is quite dynamic and tends to vary over time and between different users. The application of heuristic techniques thus often results in a false alarm whenever a user does anything unusual, leading computer users to disable such software or set the sensitivity of such software so low to the point where new viruses are often not identified.

### SUMMARY OF THE INVENTION

The present invention seeks to provide for the detection and containment of malicious computer programs that overcomes disadvantages of the prior art.

In one aspect of the present invention a computer virus detection and containment system is provided including at least one computer configured with at least one decoy address, and a server operative to identify activity occurring at the computer, the activity involving the decoy address.

In another aspect of the present invention the server is operative to perform at least one virus containment action upon identifying the activity.

In another aspect of the present invention the server is operative to receive messages sent from the computer, determine whether any of the messages are addressed to any of the decoy addresses, and upon determining that at least one of the messages is addressed to any of the decoy addresses, perform the virus containment action.

In another aspect of the present invention the computer is configured to operate as the server.

In another aspect of the present invention the virus containment action is preventing any of the messages sent by the computer from being forwarded to their intended recipients.

In another aspect of the present invention the virus containment action is forwarding any of the messages that are addressed to a decoy address to a third party for analysis.

In another aspect of the present invention the virus containment action is notifying a user at the computer that at least one of the messages is addressed to any of the decoy addresses.

In another aspect of the present invention the virus containment action is notifying a system administrator that at least one of the messages is addressed to any of the decoy addresses.

In another aspect of the present invention the virus containment action is preventing any messages at the server from being forwarded to their intended destinations.

In another aspect of the present invention the virus containment action is revoking any privileges that the computer has to access a network.

In another aspect of the present invention the virus containment action is revoking any privileges that the computer has to access shared network files or directories.

In another aspect of the present invention the virus containment action is sending a command to a network device connected a network to block attempts by the computer to access the network.

In another aspect of the present invention the server is operative to buffer any of the messages received from the computer for a predetermined delay period prior to forwarding the messages to their intended recipients.

In another aspect of the present invention the virus containment action is changing the delay period for all of the messages sent by the computer and buffered by the server.

In another aspect of the present invention the virus containment action is changing the delay period for all messages buffered by the server.

In another aspect of the present invention the messages are electronic mail messages.

In another aspect of the present invention a computer virus detection and containment system is provided including a computer configured with at least one decoy address and operative to periodically address a decoy message to one or more of the decoy addresses, and a server operative to receive messages sent from the computer, determine whether any of the messages are addressed to any of the decoy addresses, and upon determining that at least one of the messages is addressed to any of the decoy addresses, determine whether the decoy-addressed message is a valid decoy message, and upon determining that the decoy-addressed message is not a valid decoy message, perform at least one virus containment action.

In another aspect of the present invention the computer is configured to operate as the server.

In another aspect of the present invention the virus containment action is sending a command to a network device connected a network to block attempts by the computer to access the network.

In another aspect of the present invention the computer is operative to periodically send the decoy messages according to a schedule that is known in advance to the server.

In another aspect of the present invention at least one characteristic of the decoy message is known in advance to the server.

In another aspect of the present invention the computer is operative to send a plurality of decoy messages to a plurality of decoy addresses at various frequencies.

In another aspect of the present invention the server is operative to buffer any of the messages received from the computer for a predetermined delay period prior to forwarding the messages to their intended recipients.

In another aspect of the present invention the virus containment action is changing the delay period for all of the messages sent by the computer and buffered by the server.

In another aspect of the present invention the virus containment action is changing the delay period for all messages buffered by the server.

In another aspect of the present invention the messages are electronic mail messages.

In another aspect of the present invention a computer virus detection and containment system is provided including a plurality of computers, and a server operative to collect information regarding target behavior detected at any of the computers, correlate the target behavior, determine whether the correlated target behavior information corresponds to a predefined suspicious behavior pattern, and, if so, perform at least one virus containment action.

In another aspect of the present invention any of the computers is configured with at least one target behavior profile, and where the configured computer is operative to detect the target behavior and report the presence of the target behavior to the server.

In another aspect of the present invention the server is configured with at least one target behavior profile, and where the server is operative to detect the target behavior at any of the computers.

In another aspect of the present invention any of the computers is configured to operate as the server.

In another aspect of the present invention the virus containment action is preventing any messages sent by any of the computers from being forwarded to their intended recipients.

In another aspect of the present invention the virus containment action is notifying a user at any of the computers that the suspicious behavior pattern has been detected.

In another aspect of the present invention the virus containment action is notifying a system administrator that the suspicious behavior pattern has been detected.

In another aspect of the present invention the virus containment action is revoking any privileges that any of the computers has to access a network.

In another aspect of the present invention the virus containment action is revoking any privileges that any of the computers has to access shared network files or directories.

In another aspect of the present invention the virus containment action is sending a command to a network device connected a network to block attempts by any of the computers to access the network.

In another aspect of the present invention a computer virus detection and containment system is provided including a computer operative to send messages, and a server operative to receive messages sent from the computer, buffer any of the messages received from the computer for a predetermined delay period prior to forwarding the messages to their intended recipients, and perform at least one virus containment action upon the buffer.

In another aspect of the present invention the virus containment action is preventing any of the messages sent by the computer from being forwarded from the buffer to their intended recipients.

In another aspect of the present invention the virus containment action is preventing any messages from being forwarded from the buffer to their intended destinations.

In another aspect of the present invention the virus containment action is changing the delay period for all of the messages sent by the computer and buffered by the server.

In another aspect of the present invention the virus containment action is changing the delay period for all messages buffered by the server.

In another aspect of the present invention the delay period is variably adjustable according to any of a plurality of desired levels of system alertness.

In another aspect of the present invention the delay period is variably adjustable according to any of a plurality of types of messages.

In another aspect of the present invention the delay period is variably adjustable according to any of a plurality of types of attachments.

In another aspect of the present invention the delay period is variably adjustable for different users.

In another aspect of the present invention the delay period is variably adjustable for different uses activities.

In another aspect of the present invention the delay period is variably adjustable for different destinations.

In another aspect of the present invention the server is operative to increase the delay period by a predetermined amount of time upon detecting suspected virus activity, and perform the virus containment action if, during the increased delay period, additional suspected virus activity is detected and no indication that the activity is not virus related is received.

In another aspect of the present invention the server is operative to reduce the delay period to its previous level if, during the increased delay period, additional suspected virus activity is not detected.

In another aspect of the present invention the server is operative to reduce the delay period to its previous level if, during the increased delay period, an indication that the activity is not virus related is received.

In another aspect of the present invention the messages are electronic mail messages.

In another aspect of the present invention a computer virus detection and containment system is provided including at least one computer configured with at least one decoy address, and a server configured with the decoy address and operative to periodically send to the computer at least one decoy message addressed from the decoy address, where the computer is operative to receive messages sent from the server, determine whether any of the messages sent from the server are addressed from the decoy address, and upon determining that at least one of the messages sent from the server is addressed from the decoy address, send a response decoy message addressed to the decoy address to the server in response to receiving the decoy message from the server, and where the server is operative to receive messages sent from the computer, determine whether any of the messages sent from the computer are addressed to the decoy address, and upon determining that at least one of the messages sent from the computer is addressed to the decoy address, determine whether the decoy-addressed message is a valid decoy message, and upon determining that the decoy-addressed message is not a valid decoy message, perform at least one virus containment action.

In another aspect of the present invention the response decoy message is the same as the decoy message received from the server.

In another aspect of the present invention the computer is operative to open the decoy message received from the server prior to sending the response decoy message to the server.

In another aspect of the present invention the computer is operative to open an attachment attached to the decoy message received from the server prior to sending the response decoy message to the server.

In another aspect of the present invention the computer is configured to operate as the server.

In another aspect of the present invention the virus containment action is preventing any messages at the server from being forwarded to their intended destinations.

In another aspect of the present invention the virus containment action is revoking any privileges that the computer has to access a network.

In another aspect of the present invention the virus containment action is revoking any privileges that the computer has to access shared network files or directories.

In another aspect of the present invention the virus containment action is sending a command to a network device connected a network to block attempts by the computer to access the network.

In another aspect of the present invention the server is operative to periodically send the decoy messages according to a schedule that is known in advance to the computer.

In another aspect of the present invention at least one characteristic of the decoy message sent to the computer is known in advance to the computer.

In another aspect of the present invention the server is operative to buffer any of the messages received from the computer for a predetermined delay period prior to forwarding the messages to their intended recipients.

In another aspect of the present invention the virus containment action is changing the delay period for all of the messages sent by the computer and buffered by the server.

In another aspect of the present invention the virus containment action is changing the delay period for all messages buffered by the server.

In another aspect of the present invention the messages are electronic mail messages.

In another aspect of the present invention a computer virus detection and containment system is provided including a plurality of servers, each configured to maintain a virus detection sensitivity level, and multiple pluralities of computers, each plurality of computers being in communication with at least one of the servers, where each of the servers is operative to detect suspected virus activity at any of its related plurality of computers, notify any of the servers of the detected suspected virus activity, and adjust the virus detection sensitivity level according to a predefined plan.

In another aspect of the present invention the predefined plan is in predefined relation to the notification. In another aspect of the present invention the adjustment is a lengthening of a message buffer delay period.

In another aspect of the present invention the adjustment is selecting virus containment actions which are performed when a suspected virus is detected at any of the computers.

In another aspect of the present invention the different servers may track different sets of decoys or decoy types or different target behaviors.

In another aspect of the present invention the adjustment is selecting target behavior to be tracked at the computers.

In another aspect of the present invention the adjustment is selecting which correlations of target behavior are performed for target behavior detected at any of the computers.

In another aspect of the present invention the adjustment is selecting quantifications of suspicious behavior patterns.

In another aspect of the present invention a method for computer virus detection and containment is provided, the method including configuring at least one computer with at least one decoy address, and identifying activity occurring at the computer, the activity involving the decoy address. In another aspect of the present invention and further including performing at least one virus containment action upon identifying the activity.

In another aspect of the present invention the identifying step includes receiving messages sent from the computer, determining whether any of the messages are addressed to any of the decoy addresses, and where the performing step includes performing upon determining that at least one of the messages is addressed to any of the decoy addresses.

In another aspect of the present invention the performing step includes preventing any of the messages sent by the computer from being forwarded to their intended recipients.

In another aspect of the present invention the performing step includes forwarding any of the messages that are addressed to a decoy address to a third party for analysis.

In another aspect of the present invention the performing step includes notifying a user at the computer that at least one of the messages is addressed to any of the decoy addresses.

In another aspect of the present invention the performing step includes notifying a method administrator that at least one of the messages is addressed to any of the decoy addresses.

In another aspect of the present invention the performing step includes preventing any messages received from the computer from being forwarded to their intended destinations.

In another aspect of the present invention the performing step includes revoking any privileges that the computer has to access a network.

In another aspect of the present invention the performing step includes revoking any privileges that the computer has to access shared network files or directories.

In another aspect of the present invention the performing step includes sending a command to a network device connected a network to block attempts by the computer to access the network.

In another aspect of the present invention and further including buffering any of the messages received from the computer for a predetermined delay period prior to forwarding the messages to their intended recipients.

In another aspect of the present invention the performing step includes changing the delay period for all of the buffered messages sent by the computer.

In another aspect of the present invention the performing step includes changing the delay period for all messages buffered by a server.

In another aspect of the present invention a method for computer virus detection and containment is provided, the method including configuring a computer with at least one decoy address, periodically sending a decoy message addressed to one or more of the decoy addresses, receive messages sent from the computer, determining whether any of the messages are addressed to any of the decoy addresses, upon determining that at least one of the messages is addressed to any of the decoy addresses, determining whether the decoy-addressed message is a valid decoy message, and upon determining that the decoy-addressed message is not a valid decoy message, performing at least one virus containment action.

In another aspect of the present invention the performing step includes sending a command to a network device connected a network to block attempts by the computer to access the network.

In another aspect of the present invention and further including configuring a server at which the messages are received with a schedule, and where the periodically sending step includes sending the decoy messages according to the schedule.

In another aspect of the present invention and further including configuring a server at which the messages are received with at least one characteristic of the decoy message.

In another aspect of the present invention the sending step includes sending a plurality of decoy messages to a plurality of decoy addresses at various frequencies.

In another aspect of the present invention and further including buffering any of the messages received from the computer for a predetermined delay period prior to forwarding the messages to their intended recipients.

In another aspect of the present invention the performing step includes changing the delay period for all of the messages sent by the computer and buffered by a server.

In another aspect of the present invention the performing step includes changing the delay period for all messages buffered by a server.

In another aspect of the present invention a method for computer virus detection and containment is provided, the method including collecting information regarding target behavior detected at any of a plurality of computers, correlating the target behavior, determining whether the correlated target behavior information corresponds to a predefined suspicious behavior pattern, and, if so, performing at least one virus containment action.

In another aspect of the present invention and further including configuring any of the computers with at least one target behavior profile, and reporting the presence of the target behavior to a server.

In another aspect of the present invention and further including configuring a server with at least one target behavior profile, and detecting at the server the target behavior at any of the computers.

In another aspect of the present invention the performing step includes preventing any messages sent by any of the computers from being forwarded to their intended recipients.

In another aspect of the present invention the performing step includes notifying a user at any of the computers that the suspicious behavior pattern has been detected.

In another aspect of the present invention the performing step includes notifying a method administrator that the suspicious behavior pattern has been detected.

In another aspect of the present invention the performing step includes revoking any privileges that any of the computers has to access a network.

In another aspect of the present invention the performing step includes revoking any privileges that any of the computers has to access shared network files or directories.

In another aspect of the present invention the performing step includes sending a command to a network device connected a network to block attempts by any of the computers to access the network.

In another aspect of the present invention a method for computer virus detection and containment is provided, the method including receiving messages sent from a computer, buffer any of the messages received from the computer for a predetermined delay period prior to forwarding the messages to their intended recipients, and perform at least one virus containment action upon the buffer.

In another aspect of the present invention the performing step includes preventing any of the messages sent by the computer from being forwarded from the buffer to their intended recipients.

In another aspect of the present invention the performing step includes preventing any messages from being forwarded from the buffer to their intended destinations.

In another aspect of the present invention the performing step includes changing the delay period for all of the messages sent by the computer and buffered by a server.

In another aspect of the present invention the performing step includes changing the delay period for all messages buffered by a server.

In another aspect of the present invention the performing step includes variably adjusting the delay period according to any of a plurality of desired levels of method alertness.

In another aspect of the present invention the performing step includes variably adjusting the delay period according to any of a plurality of types of messages.

In another aspect of the present invention the performing step includes variably adjusting the delay period according to any of a plurality of types of attachments.

In another aspect of the present invention the performing step includes variably adjusting the delay period for different users.

In another aspect of the present invention the performing step includes variably adjusting the delay period for different uses activities.

In another aspect of the present invention the performing step includes variably adjusting the delay period for different destinations.

In another aspect of the present invention the method further includes increasing the delay period by a predetermined amount of time upon detecting suspected virus activity, and where the performing step includes performing if, during the increased delay period, additional suspected virus activity is detected and no indication that the activity is not virus related is received.

In another aspect of the present invention and the method further includes reducing the delay period to its previous level if, during the increased delay period, additional suspected virus activity is not detected.

In another aspect of the present invention and the method further includes reducing the delay period to its previous level if, during the increased delay period, an indication that the activity is not virus related is received.

In another aspect of the present invention a method for computer virus detection and containment is provided, the method including configuring at least one computer and at least one server with at least one decoy address, periodically sending from the server to the computer at least one decoy message addressed from the decoy address, at the computer receiving messages sent from the server, determining whether any of the messages sent from the server are addressed from the decoy address, upon determining that at least one of the messages sent from the server is addressed from the decoy address, sending a response decoy message addressed to the decoy address to the server in response to receiving the decoy message from the server, at the server receiving messages sent from the computer, determining whether any of the messages sent from the computer are addressed to the decoy address, upon determining that at least one of the messages sent from the computer is addressed to the decoy address, determining whether the decoy-addressed message is a valid decoy message, and upon determining that the decoy-addressed message is not a valid decoy message, performing at least one virus containment action.

In another aspect of the present invention the sending a response step includes sending the decoy message received from the server.

In another aspect of the present invention the sending a response step includes opening the decoy message received from the server prior to sending the response decoy message to the server.

In another aspect of the present invention the sending a response step includes opening an attachment attached to the decoy message received from the server prior to sending the response decoy message to the server.

In another aspect of the present invention the performing step includes preventing any messages at the server from being forwarded to their intended destinations.

In another aspect of the present invention the performing step includes revoking any privileges that the computer has to access a network.

In another aspect of the present invention the performing step includes revoking any privileges that the computer has to access shared network files or directories.

In another aspect of the present invention the performing step includes sending a command to a network device connected a network to block attempts by the computer to access the network.

In another aspect of the present invention the periodically sending step includes periodically sending the decoy messages according to a schedule that is known in advance to the computer.

In another aspect of the present invention the configuring step includes configuring the computer with at least one characteristic of the decoy message.

In another aspect of the present invention and the method further includes buffering at the server any of the messages received from the computer for a predetermined delay period prior to forwarding the messages to their intended recipients.

In another aspect of the present invention the performing step includes changing the delay period for all of the messages sent by the computer and buffered by the server. In another aspect of the present invention the performing step includes changing the delay period for all messages buffered by the server.

In another aspect of the present invention a method for computer virus detection and containment is provided including configuring each a plurality of servers to maintain a virus detection sensitivity level, and providing multiple pluralities of computers, each plurality of computers being in communication with at least one of the servers, detecting suspected virus activity at any of the plurality of computers, notifying any of the servers of the detected suspected virus activity, and adjusting the virus detection sensitivity level at any of the servers according to a predefined plan.

In another aspect of the present invention the adjusting step includes adjusting where the predefined plan is in predefined relation to the notification. In another aspect of the present invention the adjusting step includes lengthening of a message buffer delay period.

In another aspect of the present invention the adjusting step includes selecting virus containment actions which are performed when a suspected virus is detected at any of the computers.

In another aspect of the present invention the adjusting step includes selecting target behavior to be tracked at the computers.

In another aspect of the present invention the adjusting step includes selecting which correlations of target behavior are performed for target behavior detected at any of the computers.

In another aspect of the present invention the adjusting step includes selecting quantifications of suspicious behavior patterns.

The disclosures of all patents, patent applications, and other publications mentioned in this specification and of the patents, patent applications, and other publications cited therein are hereby incorporated by reference in their entirety.

### BRIEF DESCRIPTION OF THE DRAWINGS

The present invention will be understood and appreciated more fully from the following detailed description taken in conjunction with the appended drawings in which:

FIG. 1 is a simplified conceptual illustration of a computer virus detection and containment system, constructed and operative in accordance with a preferred embodiment of the present invention;

FIG. 2 is a simplified flowchart illustration of an exemplary method of operation of the system of FIG. 1, operative in accordance with a preferred embodiment of the present invention;

FIG. 3 is a simplified flowchart illustration of an exemplary method of operation of the system of FIG. 1, operative in accordance with a preferred embodiment of the present invention;

FIG. 4 is a simplified flowchart illustration of an exemplary method of operation of the system of FIG. 1, operative in accordance with a preferred embodiment of the present invention;

FIG. 5 is a simplified conceptual illustration of a computer virus detection and containment system, constructed and operative in accordance with a preferred embodiment of the present invention;

FIG. 6 is a simplified flowchart illustration of an exemplary method of operation of the system of FIG. 4, operative in accordance with a preferred embodiment of the present invention; and

FIG. 7 is a simplified flowchart illustration of an exemplary method of computer virus detection and containment, operative in accordance with a preferred embodiment of the present invention.

### DETAILED DESCRIPTION OF PREFERRED EMBODIMENTS

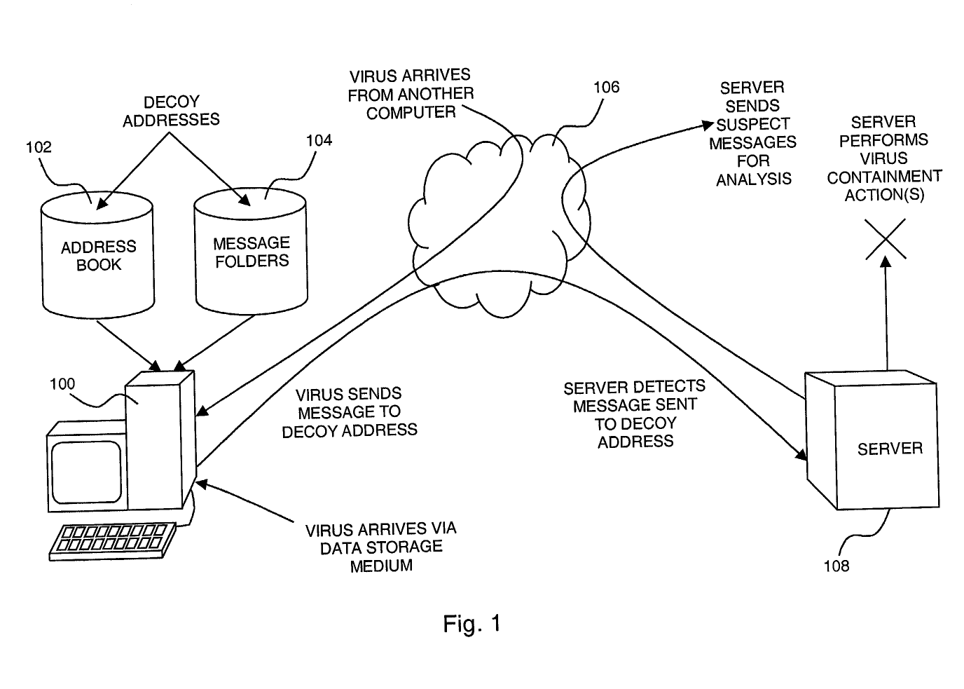

Reference is now made to FIG. 1, which is a simplified conceptual illustration of a computer virus detection and containment system, constructed and operative in accordance with a preferred embodiment of the present invention. In the system of FIG. 1 a computer 100 is shown, typically configured with client software enabling computer 100 to be used for sending and receiving messages, such as e-mail messages. The client software typically includes one or more address books 102 as well as one or more folders 104, such as “inbox” and “sent” folders for storing received and sent messages. Computer 100 is also configured to communicate via a network 106, such as the Internet. Messages sent by computer 100 via network 106 are typically first received by a server 108 which then forwards the messages to their intended recipients, preferably after a predefined delay period.

In accordance with the present invention one or more decoy addresses are inserted into either or both address book 102 and folders 104. In folders 104 the decoy addresses may be included within stored messages. Decoy addresses may also be included within other files stored on computer 100, such as HTML files. Decoy addresses may be valid addresses, such as addresses that terminate at server 108, or invalid addresses, and are preferably not addresses that are otherwise found in address book 102 and folders 104 and that might be purposely used by a user at computer 100. The decoy addresses are preferably known in advance to server 108. Preferably, the decoy addresses are not addresses that terminate at servers outside of a predefined group of servers, such as that which may be defined for a company or other organization. Alternatively, the decoy addresses may be terminated at a server located at a managed security service provider which provides virus detection and containment services for the network of computer 100.

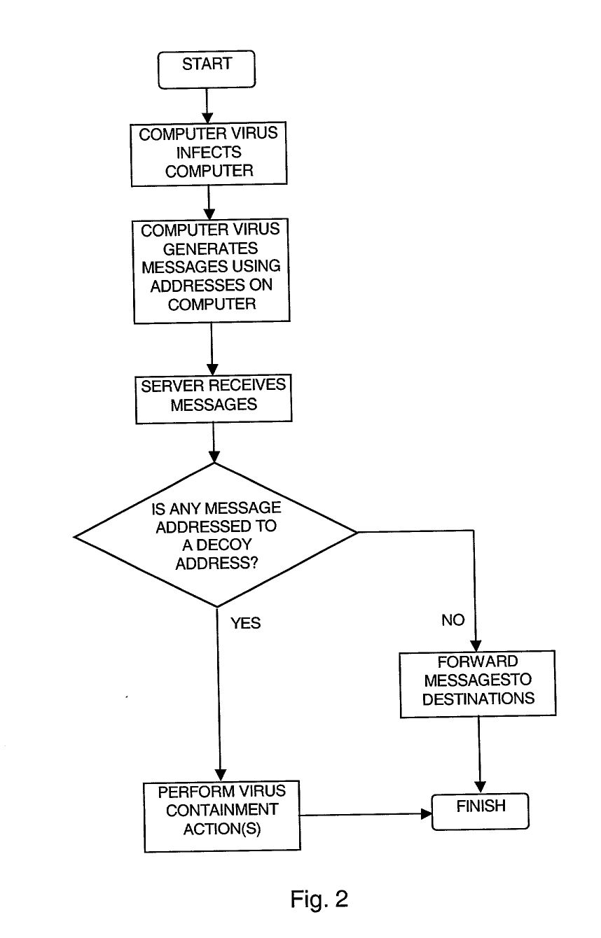

Reference is now made to FIG. 2, which is a simplified flowchart illustration of an exemplary method of operation of the system of FIG. 1, operative in accordance with a preferred embodiment of the present invention. In the method of FIG. 2, computer 100 becomes infected by a computer virus, such as by receiving the virus from another computer via a network 102 or via the introduction of infected data storage media such as a diskette or a compact disc into computer 100. As the virus attempts to propagate it selects one or more valid and decoy addresses from address book 102 and folders 104, automatically generates messages that incorporate the virus, typically as an attachment, and forwards the messages to server 108. Server 108 scans messages received from computer 100. Should server 108 detect a message addressed to a decoy address, server 108 may initiate one or more virus containment actions such as, but not limited to:

Suspending any or all messages sent by computer 100, thereby preventing messages sent by computer 100 from being forwarded to recipients.

Forwarding messages that are addressed to a decoy address to a third party for analysis, such as a company or other body that produces anti-virus software.

Notifying a user at computer 100 of the suspicious message activity.

Notifying a system administrator that a virus may have been detected.

Stopping all messages from being forwarded by server 108 to their intended destinations. Taking away all privileges that computer 100 has to access network 102 and/or rights to access shared network files or directories.

Changing the delay period of all messages received by server 108, thus putting the entire network on “virus alert.”;

Sending a command to network devices connected to network 102, such as switches or routers, to block all attempts by computer 100 to access network 102. This may be done, for example, by using SNMP commands.

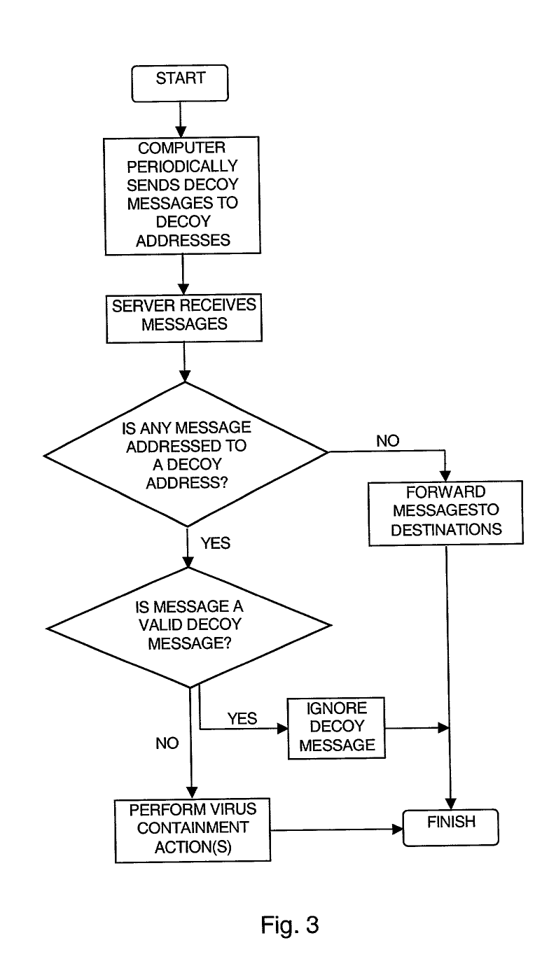

Reference is now made to FIG. 3, which is a simplified flowchart illustration of an exemplary method of operation of the system of FIG. 1, operative in accordance with a preferred embodiment of the present invention. In the method of FIG. 3 computer 100 is configured to periodically send decoy messages to one or more of the decoy addresses, with or without attachments, and in a manner that would enable server 108 to determine that the messages are valid decoy messages and not messages sent by a virus. For example, computer 100 may send decoy messages according to a schedule that is known in advance to server 108, or may include text and/or attachments whose characteristics are known in advance to server 108. Should computer 100 become infected by a computer virus that generates its own messages, as the virus attempts to propagate it selects one or more valid and decoy addresses from address book 102 and folders 104, automatically generates messages that incorporate the virus, typically as an attachment, and forwards the messages to server 108. Alternatively, should computer 100 become infected by a computer virus that attaches itself to outgoing messages that it does not automatically generate, the virus will attach itself to a periodic decoy message.

The method of FIG. 3 continues with server 108 scanning messages received from computer 100. Should server 108 detect a message addressed to a decoy address, server 108 determines whether the message is a valid decoy message or otherwise. If the message is not a valid a decoy message, and, therefore, possibly a message sent by a virus, server 108 may initiate one or more virus containment actions such as is described hereinabove with reference to FIG. 2.

In order to “bait” computer viruses that selectively choose for propagation addresses from address book 102 and folders 104 based on usage, such as by selecting addresses to which computer 100 most recently sent message or to which computer 100 most frequently sends messages, computer 100 preferably sends decoy messages to different decoy addresses at various frequencies in order not to distinguish the pattern of decoy messages from computer 100's normal message-sending patterns.

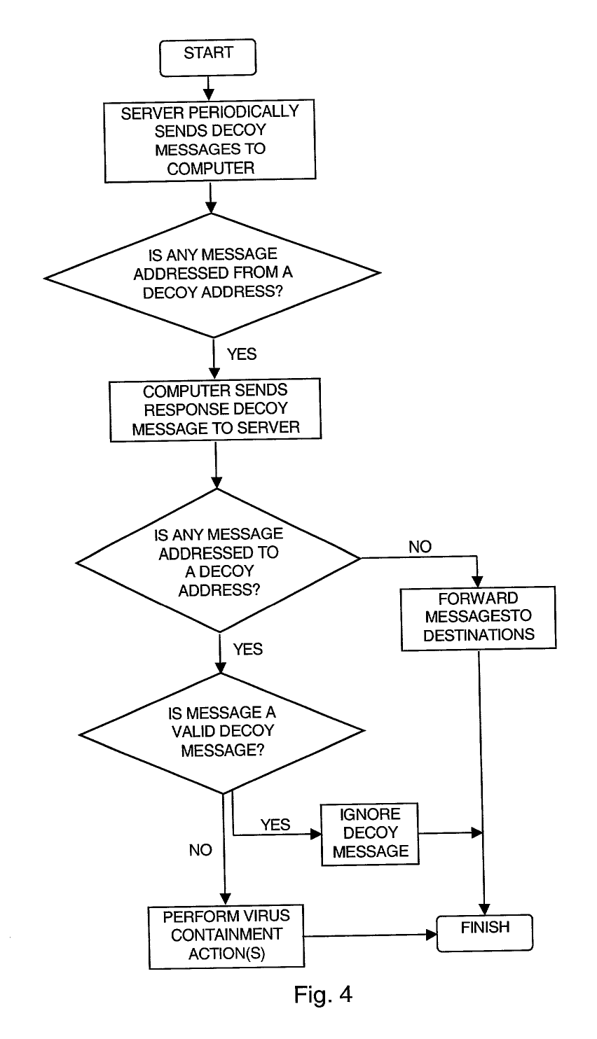

Reference is now made to FIG. 4, which is a simplified flowchart illustration of an exemplary method of operation of the system of FIG. 1, operative in accordance with a preferred embodiment of the present invention. In the method of FIG. 4 server 108 is configured to periodically send decoy messages to computer 100, with or without attachments. Each decoy message preferably indicates that it was sent from a decoy address known in advance to computer 100. Upon detecting the decoy message, computer 100 replies to the decoy message by sending a decoy message of its own to the decoy address indicated in server 108's decoy message, either immediately or according to a schedule that is known in advance to server 108. The decoy message sent by computer 100 may be the same decoy message sent by server 108, or may be a different decoy message including text and/or attachments whose characteristics are known in advance to server 108. Where computer 100 sends the decoy message received from server 108 back to server 108, computer 100 may be configured to open the decoy message and/or its attachment prior to sending in order to “bait” viruses that look for such activity.

The method of FIG. 4 continues with server 108 scanning messages received from computer 100. Should server 108 detect a message addressed to a decoy address, server 108 determines whether the message is a valid decoy message or otherwise. If the message is not a valid a decoy message, and, therefore, possibly a message sent by a virus or a message changed by a virus, server 108 may initiate one or more virus containment actions such as is described hereinabove with reference to FIG. 2.

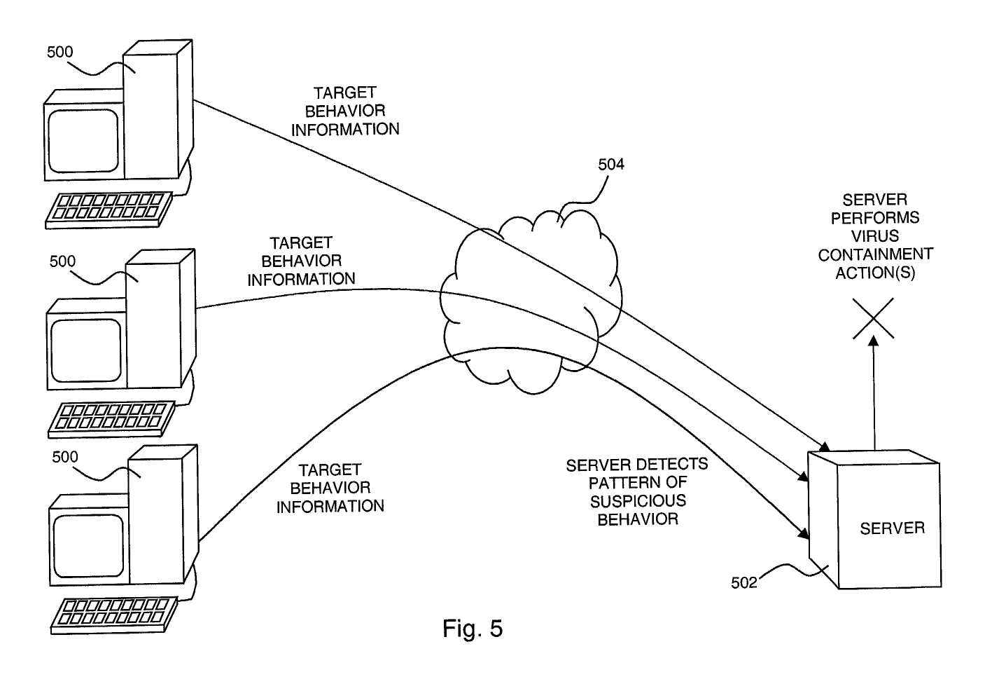

Reference is now made to FIG. 5, which is a simplified conceptual illustration of a computer virus detection system, constructed and operative in accordance with a preferred embodiment of the present invention. In the system of FIG. 5 one or more computers 500 are shown, being configured to communicate with a server 502 via a network 504, such as the Internet.

As was noted hereinabove, computer viruses typically infect a computer system by moving from one computer to another within a computer network, such as via messages and through the copying or sharing of files. One characteristic of such types of infection is that computers that share the same network services are often infected within the same time period. A computer virus can thus be detected by correlating behavior and/or data from different computers. Activity that cannot be confidently attributed to a virus when observed on one computer can be clearly identified as such when observed on several computers in a network.

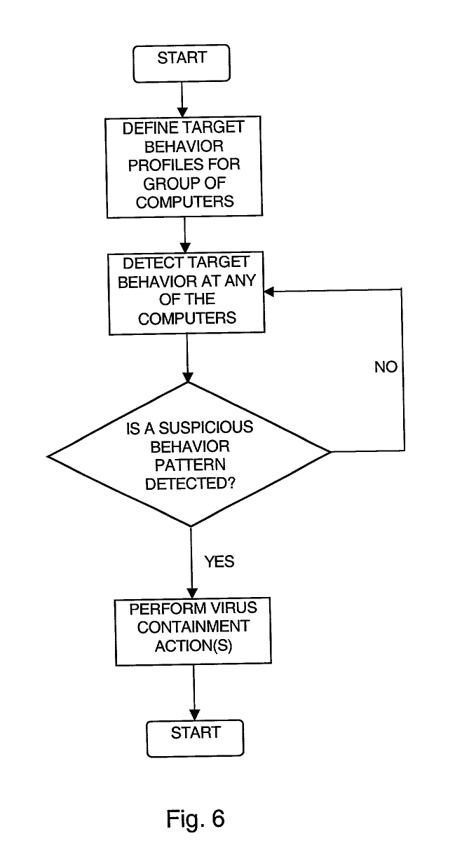

Reference is now made to FIG. 6, which is a simplified flowchart illustration of an exemplary method of operation of the system of FIG. 5, operative in accordance with a preferred embodiment of the present invention. In the method of FIG. 6 one or more target behavior profiles are defined for computers 500. Each target behavior profile describes behavior that should be the subject of correlation analysis as described in greater detail hereinbelow. Target behavior may be any and all computer activity. Some examples of target behavior profiles include:

Sending messages to more than a predefined number of users during a predefined period of time;

Sending messages not as a result of a direct user interaction with the Graphic User Interface (GUI) of the message software, but rather as the result of a directive from a software application;

Modifying operating system files such as the Microsoft Windows registry;

Deleting more than a predefined number of files on the computer's hard disk during a predefined period of time;

Loading a new software application into the computer's RAM;

Sending a file attached to a message several times from the same user;

Sending a file attachment of a specific type (e.g., .exe, .doc, .zip);

Attempting to contact previously unused or unknown IP addresses or IP Sockets.

Computers 500 may be configured with such target behavior profiles and the ability to detect associated target behavior and notify server 502 accordingly. Additionally or alternatively, server 502 may be configured with such target behavior profiles and may detect associated target behavior at computers 500 using conventional techniques. After collecting information regarding target behavior detected at two or more of computers 500, server 502 may then correlate the presence of target behavior detected at two or more of computers 500 in order to determine whether the correlated target behavior corresponds to a predefined suspicious behavior pattern of target behavior as an indication that a computer virus may have infected those computers. Any known behavior correlation techniques may be used, such as identifying the same activity in different computers at about the same time, or by identifying repeating patterns of data within the memories of two or more computers.

Examples of expressions of such suspicious behavior patterns include:

A certain percentage of the computers in the network sending more than 10 messages per minute in the last 5 minutes;

A certain percentage of the computers in the network sending messages not initiated via the message GUI in the last 1 minute;

A certain percentage of the computers in the network deleting more than 10 files in the last 1 minute;

A certain percentage of computers in the network deleting a file by the same name within the last 1 hour.

certain percentage of the computers in the network deleting a file with the same name in the last 1 minute;

A certain percentage of the computers in the network to which changes to the Microsoft Windows Registry occurred in the last 1 minute;

A certain percentage of the computers in the network sending the same file attachment via a message in the last 15 minutes;

A certain percentage of the computers in the network sending file attachments via one or more messages in the last hour where each of the files includes the same string of bits;

A certain percentage of the computers in the network having an unusual level of correlation of data between files sent as attachments. For example, since viruses known as “polymorphic viruses” may change their name as they move from one computer to another, one way to identify such viruses is to identify attachments that have the same or similar data, whether or not they have the same name.

Upon detecting a suspicious behavior pattern server 502 may initiate one or more virus containment actions such as is described hereinabove with reference to FIG. 2.

In the systems and methods described hereinabove with reference to FIGS. 1, 2, 3, 4, 5, and 6, the server may include a buffer or other mechanism whereby messages received from the computer are held, typically for a predefined delay period, prior to forwarding the messages to their intended recipients. In this way, should a computer virus send one or more infected messages to valid, non-decoy addresses before sending an infected message to a decoy address, the infected messages to valid, non-decoy addresses that are still held at the server may be “quarantined” at the server and thus prevented, together with the infected message to a decoy address, from reaching their intended destinations. The server may also notify a system administrator of the quarantined messages who may then check the quarantined to determine whether or not the messages were indeed sent by a computer virus and either allow them to be forwarded to their intended recipients as is, should they not be infected, or only after they have been disinfected. The delay period may be set according to different desired levels of system alertness. The delay period may be applied selectively only to certain types of messages, such as those that have attachments or specific types of attachments (e.g., only .exe, .doc, .xls and .zip file types). This, too, may be applied selectively according to different desired levels of system alertness. The delay period may also vary for different users, different activities (e.g., such as sending or receiving messages), and/or for messages whose destination is outside of a company or other organization versus internal messages.

In an alternative implementation of the buffer described above that is designed to reduce false alarms, should the server receive an invalid decoy message, or should suspicious behavior be detected for multiple computers, the buffer delay period may be increased by a predetermined amount of time, and users may be notified. During the increased delay period, should additional suspicious messages be received, or should other suspicious behavior be detected, if the user and/or system administrator who is authorized to do so has not indicated that the activity is not virus related, only then does the server perform one or more virus containment actions. If, however, during the increased delay period no other suspicious activity is detected, or if the user and/or system administrator who is authorized to do so has indicated that the activity is not virus related, the delay period may be reduced to its previous level and no virus containment action is performed.

It is appreciated that in any of the embodiments described hereinabove computer 100/500 may be configured to act as server 108/502 as well, with computer 100/500 sending decoy and other messages to itself for processing as described hereinabove.

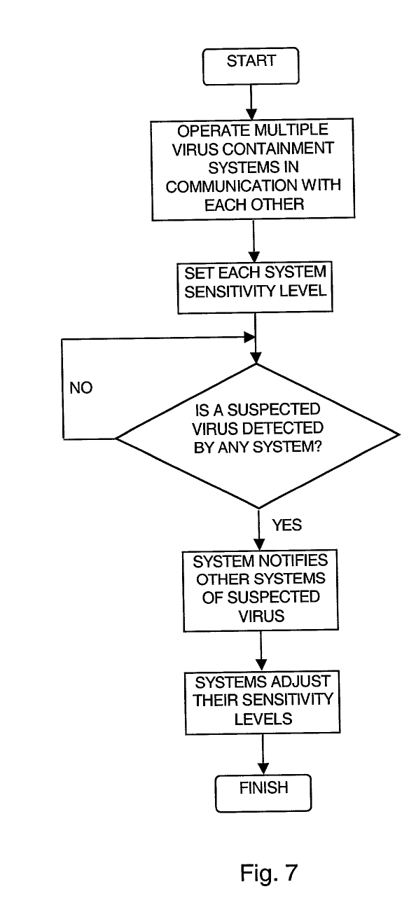

Reference is now made to FIG. 7, which is a simplified flowchart illustration of an exemplary method of virus detection and containment, operative in accordance with a preferred embodiment of the present invention. In the method of FIG. 7 a number of virus detection and containment systems are implemented, each system being configured as described hereinabove with reference to FIGS. 1, 2, 3, 4, 5, and 6, and their various servers being in communication with each other. Each system may have the same sensitivity level as expressed by sensitivity parameters such as length of message buffer delay period, which and how many virus containment actions are performed when a suspected virus is detected, which target behavior is tracked, and/or which correlations of target behavior are performed and what are the thresholds for identifying suspicious behavior patterns. Alternatively, different systems may have greater or lesser sensitivity levels, or simply different sensitivity levels by employing different sensitivity parameters. Alternatively, each system may use different system decoys and/or monitor different correlation parameters. It is believed that such diversification between different virus containment systems will improve the chances that at least some of the systems will identify a previously unknown virus. Once one system detects a suspected virus it may notify other systems of the suspected virus. Each system may then increase or otherwise adjust its sensitivity level, preferably according to a predefined adjustment plan and preferably in predefined relation to said notification. For example, if one system detects a suspected virus using a specific decoy or correlation parameter, other systems may heighten their sensitivity level related to that decoy or correlation parameter. It is appreciated that the identification of virus activity may include automatic identification of suspicious activity by a server or a combination of automatic identification and a notification of a system operator and approval by that operator that the suspicious activity is truly a virus, before notifying other servers.

It is appreciated that one or more of the steps of any of the methods described herein may be omitted or carried out in a different order than that shown, without departing from the true spirit and scope of the invention.

While the methods and apparatus disclosed herein may or may not have been described with reference to specific hardware or software, it is appreciated that the methods and apparatus described herein may be readily implemented in hardware or software using conventional techniques.

While the present invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

What is claimed is:

1. A computer virus detection and containment system comprising:
at least one computer configured with at least one decoy address; and
a server operative to:
identify activity occurring at said computer, said activity involving said decoy address.

2. A system according to claim 1 wherein said server is operative to perform at least one virus containment action upon identifying said activity.

3. A system according to claim 2 wherein:
said server is operative to:
receive messages sent from said computer,
determine whether any of said messages are addressed to any of said decoy addresses, and
upon determining that at least one of said messages is addressed to any of said decoy addresses, perform said virus containment action.

4. A system according to claim 3 wherein said computer is configured to operate as said server.

5. A system according to claim 3 wherein said virus containment action is preventing any of said messages sent by said computer from being forwarded to their intended recipients.

6. A system according to claim 3 wherein said virus containment action is forwarding any of said messages that are addressed to a decoy address to a third party for analysis.

7. A system according to claim 3 wherein said virus containment action is notifying a user at said computer that at least one of said messages is addressed to any of said decoy addresses.

8. A system according to claim 3 wherein said virus containment action is notifying a system administrator that at least one of said messages is addressed to any of said decoy addresses.

9. A system according to claim 3 wherein said virus containment action is preventing any messages at said server from being forwarded to their intended destinations.

10. A system according to claim 3 wherein said virus containment action is revoking any privileges that said computer has to access a network.

11. A system according to claim 3 wherein said virus containment action is revoking any privileges that said computer has to access shared network files or directories.

12. A system according to claim 3 wherein said virus containment action is sending a command to a network device connected a network to block attempts by said computer to access said network.

13. A system according to claim 3 wherein said server is operative to buffer any of said messages received from said computer for a predetermined delay period prior to forwarding said messages to their intended recipients.

14. A system according to claim 13 wherein said virus containment action is changing said delay period for all of said messages sent by said computer and buffered by said server.

15. A system according to claim 13 wherein said virus containment action is changing said delay period for all messages buffered by said server.

16. A system according to claim 3 wherein said messages are electronic mail messages.

17. A computer virus detection and containment system comprising:
a computer configured with at least one decoy address and operative to periodically address a decoy message to one or more of said decoy addresses; and
a server operative to:
receive messages sent from said computer,
determine whether any of said messages are addressed to any of said decoy addresses, and
upon determining that at least one of said messages is addressed to any of said decoy addresses, determine whether said decoy-addressed message is a valid decoy message, and
upon determining that said decoy-addressed message is not a valid decoy message, perform at least one virus containment action.

18. A system according to claim 17 wherein said computer is configured to operate as said server.

19. A system according to claim 17 wherein said virus containment action is sending a command to a network device connected a network to block attempts by said computer to access said network.

20. A system according to claim 17 wherein said computer is operative to periodically send said decoy messages according to a schedule that is known in advance to said server.

21. A system according to claim 17 wherein at least one characteristic of said decoy message is known in advance to said server.

22. A system according to claim 17 wherein said computer is operative to send a plurality of decoy messages to a plurality of decoy addresses at various frequencies.

23. A system according to claim 17 wherein said server is operative to buffer any of said messages received from said computer for a predetermined delay period prior to forwarding said messages to their intended recipients.

24. A system according to claim 23 wherein said virus containment action is changing said delay period for all of said messages sent by said computer and buffered by said server.

25. A system according to claim 23 wherein said virus containment action is changing said delay period for all messages buffered by said server.

26. A system according to claim 17 wherein said messages are electronic mail messages.

27. A computer virus detection and containment system comprising:
a plurality of computers; and
a server operative to:
collect information regarding target behavior detected at any of said computers;
correlate said target behavior;
determine whether said correlated target behavior information corresponds to a predefined suspicious behavior pattern, and, if so;
perform at least one virus containment action.

28. A system according to claim 27 wherein any of said computers is configured with at least one target behavior profile, and wherein said configured computer is operative to detect said target behavior and report the presence of said target behavior to said server.

29. A system according to claim 27 wherein said server is configured with at least one target behavior profile, and wherein said server is operative to detect said target behavior at any of said computers.

30. A system according to claim 27 wherein any of said computers is configured to operate as said server.

31. A system according to claim 27 wherein said virus containment action is preventing any messages sent by any of said computers from being forwarded to their intended recipients.

32. A system according to claim 27 wherein said virus containment action is notifying a user at any of said computers that said suspicious behavior pattern has been detected.

33. A system according to claim 27 wherein said virus containment action is notifying a system administrator that said suspicious behavior pattern has been detected.

34. A system according to claim 27 wherein said virus containment action is revoking any privileges that any of said computers has to access a network.

35. A system according to claim 27 wherein said virus containment action is revoking any privileges that any of said computers has to access shared network files or directories.

36. A system according to claim 27 wherein said virus containment action is sending a command to a network device connected a network to block attempts by any of said computers to access said network.

37. A computer virus detection and containment system comprising:
a computer operative to send messages; and
a server operative to:
receive messages sent from said computer,
buffer any of said messages received from said computer for a predetermined delay period prior to forwarding said messages to their intended recipients; and
perform at least one virus containment action upon said buffer.

38. A system according to claim 37 wherein said virus containment action is preventing any of said messages sent by said computer from being forwarded from said buffer to their intended recipients.

39. A system according to claim 37 wherein said virus containment action is preventing any messages from being forwarded from said buffer to their intended destinations.

40. A system according to claim 37 wherein said virus containment action is changing said delay period for all of said messages sent by said computer and buffered by said server.

41. A system according to claim 37 wherein said virus containment action is changing said delay period for all messages buffered by said server.

42. A system according to claim 37 wherein said delay period is variably adjustable according to any of a plurality of desired levels of system alertness.

43. A system according to claim 37 wherein said delay period is variably adjustable according to any of a plurality of types of messages.

44. A system according to claim 37 wherein said delay period is variably adjustable according to any of a plurality of types of attachments.

45. A system according to claim 37 wherein said delay period is variably adjustable for different users.

46. A system according to claim 37 wherein said delay period is variably adjustable for different uses activities.

47. A system according to claim 37 wherein said delay period is variably adjustable for different destinations.

48. A system according to claim 37 wherein said server is operative to:
increase said delay period by a predetermined amount of time upon detecting suspected virus activity, and
perform said virus containment action if, during said increased delay period, additional suspected virus activity is detected and no indication that said activity is not virus related is received.

49. A system according to claim 48 wherein said server is operative to:
reduced said delay period to its previous level if, during said increased delay period, additional suspected virus activity is not detected.

50. A system according to claim 48 wherein said server is operative to:
reduced said delay period to its previous level if, during said increased delay period, an indication that said activity is not virus related is received.

51. A system according to claim 37 wherein said messages are electronic mail messages.

52. A computer virus detection and containment system comprising:
at least one computer configured with at least one decoy address; and
a server configured with said decoy address and operative to periodically send to said computer at least one decoy message addressed from said decoy address;
wherein said computer is operative to:
receive messages sent from said server,
determine whether any of said messages sent from said server are addressed from said decoy address, and
upon determining that at least one of said messages sent from said server is addressed from said decoy address, send a response decoy message addressed to said decoy address to said server in response to receiving said decoy message from said server, and
wherein said server is operative to:
receive messages sent from said computer,
determine whether any of said messages sent from said computer are addressed to said decoy address, and
upon determining that at least one of said messages sent from said computer is addressed to said decoy address, determine whether said decoy-addressed message is a valid decoy message, and
upon determining that said decoy-addressed message is not a valid decoy message, perform at least one virus containment action.

53. A system according to claim 52 wherein said response decoy message is the same as said decoy message received from said server.

54. A system according to claim 53 wherein said computer is operative to open said decoy message received from said server prior to sending said response decoy message to said server.

55. A system according to claim 53 wherein said computer is operative to open an attachment attached to said decoy message received from said server prior to sending said response decoy message to said server.

56. A system according to claim 52 wherein said computer is configured to operate as said server.

57. A system according to claim 52 wherein said virus containment action is preventing any messages at said server from being forwarded to their intended destinations.

58. A system according to claim 52 wherein said virus containment action is revoking any privileges that said computer has to access a network.

59. A system according to claim 52 wherein said virus containment action is revoking any privileges that said computer has to access shared network files or directories.

60. A system according to claim 52 wherein said virus containment action is sending a command to a network device connected a network to block attempts by said computer to access said network.

61. A system according to claim 52 wherein said server is operative to periodically send said decoy messages according to a schedule that is known in advance to said computer.

62. A system according to claim 52 wherein at least one characteristic of said decoy message sent to said computer is known in advance to said computer.

63. A system according to claim 52 wherein said server is operative to buffer any of said messages received from said computer for a predetermined delay period prior to forwarding said messages to their intended recipients.

64. A system according to claim 63 wherein said virus containment action is changing said delay period for all of said messages sent by said computer and buffered by said server.

65. A system according to claim 63 wherein said virus containment action is changing said delay period for all messages buffered by said server.

66. A system according to claim 52 wherein said messages are electronic mail messages.

67. A computer virus detection and containment system comprising:
a plurality of servers, each configured to maintain a virus detection sensitivity level; and
multiple pluralities of computers, each plurality of computers being in communication with at least one of said servers;
wherein each of said servers is operative to:
detect suspected virus activity at any of its related plurality of computers,
notify any of said servers of said detected suspected virus activity, and
adjust said virus detection sensitivity level according to a predefined plan.

68. A system according to claim 67 wherein said predefined plan is in predefined relation to said notification.

69. A system according to claim 67 wherein said adjustment is a lengthening of a message buffer delay period.

70. A system according to claim 67 wherein said adjustment is selecting virus containment actions which are performed when a suspected virus is detected at any of said computers.

71. A system according to claim 67 wherein said adjustment is selecting target behavior to be tracked at said computers.

72. A system according to claim 67 wherein said adjustment is selecting which correlations of target behavior are performed for target behavior detected at any of said computers.

73. A system according to claim 72 wherein said adjustment is selecting quantifications of suspicious behavior patterns.

74. A method for computer virus detection and containment, the method comprising:
configuring at least one computer with at least one decoy address; and
identifying activity occurring at said computer, said activity involving said decoy address.

75. A method according to claim 74 and further comprising performing at least one virus containment action upon identifying said activity.

76. A method according to claim 75 wherein:
said identifying step comprises:
receiving messages sent from said computer;
determining whether any of said messages are addressed to any of said decoy addresses; and
and wherein said performing step comprises performing upon determining that at least one of said messages is addressed to any of said decoy addresses.

77. A method according to claim 76 wherein said performing step comprises preventing any of said messages sent by said computer from being forwarded to their intended recipients.

78. A method according to claim 76 wherein said performing step comprises forwarding any of said messages that are addressed to a decoy address to a third party for analysis.

79. A method according to claim 76 wherein said performing step comprises notifying a user at said computer that at least one of said messages is addressed to any of said decoy addresses.

80. A method according to claim 76 wherein said performing step comprises notifying a method administrator that at least one of said messages is addressed to any of said decoy addresses.

81. A method according to claim 76 wherein said performing step comprises preventing any messages received from said computer from being forwarded to their intended destinations.

82. A method according to claim 76 wherein said performing step comprises revoking any privileges that said computer has to access a network.

83. A method according to claim 76 wherein said performing step comprises revoking any privileges that said computer has to access shared network files or directories.

84. A method according to claim 76 wherein said performing step comprises sending a command to a network device connected a network to block attempts by said computer to access said network.

85. A method according to claim 76 and further comprising buffering any of said messages received from said computer for a predetermined delay period prior to forwarding said messages to their intended recipients.

86. A method according to claim 85 wherein said performing step comprises changing said delay period for all of said buffered messages sent by said computer.

87. A method according to claim 85 wherein said performing step comprises changing said delay period for all messages buffered by a server.

88. A method for computer virus detection and containment, the method comprising:
configuring a computer with at least one decoy address;
periodically sending a decoy message addressed to one or more of said decoy addresses;
receive messages sent from said computer;
determining whether any of said messages are addressed to any of said decoy addresses;
upon determining that at least one of said messages is addressed to any of said decoy addresses, determining whether said decoy-addressed message is a valid decoy message; and
upon determining that said decoy-addressed message is not a valid decoy message, performing at least one virus containment action.

89. A method according to claim 88 wherein said performing step comprises sending a command to a network device connected a network to block attempts by said computer to access said network.

90. A method according to claim 88 and further comprising configuring a server at which said messages are received with a schedule, and wherein said periodically sending step comprises sending said decoy messages according to said schedule.

91. A method according to claim 88 and further comprising configuring a server at which said messages are received with at least one characteristic of said decoy message.

92. A method according to claim 88 wherein said sending step comprises sending a plurality of decoy messages to a plurality of decoy addresses at various frequencies.

93. A method according to claim 88 and further comprising buffering any of said messages received from said computer for a predetermined delay period prior to forwarding said messages to their intended recipients.

94. A method according to claim 93 wherein said performing step comprises changing said delay period for all of said messages sent by said computer and buffered by a server.

95. A method according to claim 93 wherein said performing step comprises changing said delay period for all messages buffered by a server.

96. A method for computer virus detection and containment, the method comprising:
collecting information regarding target behavior detected at any of a plurality of computers;
correlating said target behavior;
determining whether said correlated target behavior information corresponds to a predefined suspicious behavior pattern, and, if so;
performing at least one virus containment action.

97. A method according to claim 96 and further comprising:
configuring any of said computers with at least one target behavior profile; and
reporting the presence of said target behavior to a server.

98. A method according to claim 96 and further comprising:
configuring a server with at least one target behavior profile; and
detecting at said server said target behavior at any of said computers.

99. A method according to claim 96 wherein said performing step comprises preventing any messages sent by any of said computers from being forwarded to their intended recipients.

100. A method according to claim 96 wherein said performing step comprises notifying a user at any of said computers that said suspicious behavior pattern has been detected.

101. A method according to claim 96 wherein said performing step comprises notifying a method administrator that said suspicious behavior pattern has been detected.

102. A method according to claim 96 wherein said performing step comprises revoking any privileges that any of said computers has to access a network.

103. A method according to claim 96 wherein said performing step comprises revoking any privileges that any of said computers has to access shared network files or directories.

104. A method according to claim 96 wherein said performing step comprises sending a command to a network device connected a network to block attempts by any of said computers to access said network.

105. A method for computer virus detection and containment, the method comprising:
receiving messages sent from a computer,
buffer any of said messages received from said computer for a predetermined delay period prior to forwarding said messages to their intended recipients; and
perform at least one virus containment action upon said buffer.

106. A method according to claim 105 wherein said performing step comprises preventing any of said messages sent by said computer from being forwarded from said buffer to their intended recipients.

107. A method according to claim 105 wherein said performing step comprises preventing any messages from being forwarded from said buffer to their intended destinations.

108. A method according to claim 105 wherein said performing step comprises changing said delay period for all of said messages sent by said computer and buffered by a server.

109. A method according to claim 105 wherein said performing step comprises changing said delay period for all messages buffered by a server.

110. A method according to claim 105 wherein said performing step comprises variably adjusting said delay period according to any of a plurality of desired levels of method alertness.

111. A method according to claim 105 wherein said performing step comprises variably adjusting said delay period according to any of a plurality of types of messages.

112. A method according to claim 105 wherein said performing step comprises variably adjusting said delay period according to any of a plurality of types of attachments.

113. A method according to claim 105 wherein said performing step comprises variably adjusting said delay period for different users.

114. A method according to claim 105 wherein said performing step comprises variably adjusting said delay period for different uses activities.

115. A method according to claim 105 wherein said performing step comprises variably adjusting said delay period for different destinations.

116. A method according to claim 105 and further comprising:
increasing said delay period by a predetermined amount of time upon detecting suspected virus activity, and
wherein said performing step comprises performing if, during said increased delay period, additional suspected virus activity is detected and no indication that said activity is not virus related is received.

117. A method according to claim 116 and further comprising reducing said delay period to its previous level if, during said increased delay period, additional suspected virus activity is not detected.

118. A method according to claim 116 and further comprising reducing said delay period to its previous level if, during said increased delay period, an indication that said activity is not virus related is received.

119. A method for computer virus detection and containment, the method comprising:
configuring at least one computer and at least one server with at least one decoy address;
periodically sending from said server to said computer at least one decoy message addressed from said decoy address;
at said computer:
receiving messages sent from said server;
determining whether any of said messages sent from said server are addressed from said decoy address;
upon determining that at least one of said messages sent from said server is addressed from said decoy address, sending a response decoy message addressed to said decoy address to said server in response to receiving said decoy message from said server;
at said server:
receiving messages sent from said computer,
determining whether any of said messages sent from said computer are addressed to said decoy address;
upon determining that at least one of said messages sent from said computer is addressed to said decoy address, determining whether said decoy-addressed message is a valid decoy message; and
upon determining that said decoy-addressed message is not a valid decoy message, performing at least one virus containment action.

120. A method according to claim 119 wherein said sending a response step comprises sending said decoy message received from said server.

121. A method according to claim 120 wherein said sending a response step comprises opening said decoy message received from said server prior to sending said response decoy message to said server.

122. A method according to claim 120 wherein said sending a response step comprises opening an attachment attached to said decoy message received from said server prior to sending said response decoy message to said server.

123. A method according to claim 119 wherein said performing step comprises preventing any messages at said server from being forwarded to their intended destinations.

124. A method according to claim 119 wherein said performing step comprises revoking any privileges that said computer has to access a network.

125. A method according to claim 119 wherein said performing step comprises revoking any privileges that said computer has to access shared network files or directories.

126. A method according to claim 119 wherein said performing step comprises sending a command to a network device connected a network to block attempts by said computer to access said network.

127. A method according to claim 119 wherein said periodically sending step comprises periodically sending said decoy messages according to a schedule that is known in advance to said computer.

128. A method according to claim 119 wherein said configuring step comprises configuring said computer with at least one characteristic of said decoy message.

129. A method according to claim 119 and further comprising buffering at said server any of said messages received from said computer for a predetermined delay period prior to forwarding said messages to their intended recipients.

130. A method according to claim 129 wherein said performing step comprises changing said delay period for all of said messages sent by said computer and buffered by said server.

131. A method according to claim 129 wherein said performing step comprises changing said delay period for all messages buffered by said server.

132. A computer virus detection and containment method comprising:
configuring each a plurality of servers to maintain a virus detection sensitivity level; and
providing multiple pluralities of computers, each plurality of computers being in communication with at least one of said servers;
detecting suspected virus activity at any of said plurality of computers,
notifying any of said servers of said detected suspected virus activity, and
adjusting said virus detection sensitivity level at any of said servers according to a predefined plan.

133. A method according to claim 132 wherein said adjusting step comprises adjusting where said predefined plan is in predefined relation to said notification.

134. A method according to claim 132 wherein said adjusting step comprises lengthening of a message buffer delay period.

135. A method according to claim 132 wherein said adjusting step comprises selecting virus containment actions which are performed when a suspected virus is detected at any of said computers.

136. A method according to claim 132 wherein said adjusting step comprises selecting target behavior to be tracked at said computers.

137. A method according to claim 132 wherein said adjusting step comprises selecting which correlations of target behavior are performed for target behavior detected at any of said computers.

138. A method according to claim 137 wherein said adjusting step comprises selecting quantifications of suspicious behavior patterns.
